(19) United States
(12) Patent Application Publication
(10) Pub. No.: US 2007/0090556 A1
(43) Pub. Date: Apr. 26, 2007

(54) Plastic compositions formed from post consumer waste plastics and processes for making same

(75) Inventor: Andrew Steven Johnson, Grand Rapids, MI (US)

Correspondence Address: SHOOK, HARDY & BACON LLP;INTELLECTUAL PROPERTY DEPARTMENT, 2555 GRAND BLVD, KANSAS CITY, MO, 64108-2613, US

(73) Assignee: L & P Property Management Company, South Gate, CA (US)

(21) Appl. No.: 11/257,518

(22) Filed: Oct. 25, 2005

(51) Int. Cl. B29C 39/38

(52) U.S. Cl. 264/140; 264/914; 264/319; 524/27

(57) ABSTRACT

Plastic compositions formed from post consumer plastic waste and methods for making such plastic compositions are provided. In one aspect, a method for forming a plastic product includes providing a first composition comprising at least 30 weight percent of a first plastic and at least 30 weight percent paper products. The method also includes providing a second composition comprising at least 90 weight percent of a second plastic. The first and second compositions are each shredded and commingled to form a shredded mixture. The shredded mixture is heated to form a shapeable plastic, which is molded and cooled to form the plastic product.

### CROSS-REFERENCE TO RELATED APPLICATIONS

Not applicable.

### STATEMENT REGARDING FEDERALLY SPONSORED RESEARCH OR DEVELOPMENT

Not applicable.

### TECHNICAL FIELD

The present invention relates generally to plastic compositions. More particularly, the present invention relates to plastic compositions formed from post consumer waste plastics and methods for forming such plastic compositions.

### BACKGROUND

The make-up of post-consumer plastic waste poses a number of difficulties for plastic recycling. Generally, to produce high-quality recycled products, plastic recycling requires a fairly clean stream of plastic made up of materials that are relatively homogeneous. However, post-consumer plastic waste is typically contaminated with a variety of impurities, including paper, labels, paint, motor oil, adhesives, and solvents. Therefore, the plastic waste must typically be washed and cleaned before it may be recycled.

In addition to including a variety of contaminants, post-consumer plastic waste is also characterized by containing plastics of a wide assortment of polymers. Because the plastic waste is commingled, the different types of plastics must be sorted and separated. The process of cleaning and separating plastics is often expensive, preventing plastic recycling from being cost-effective. As a result, post-consumer plastic waste is often landfilled as opposed to being recycled.

A number of approaches have been taken to address the issue of cost-effectively recycling commingled and contaminated plastic waste. For example, U.S. Pat. No. 5,895,790 to Good, which is herein incorporated by reference in its entirety, discloses a method of thermosetting a wide range of polymer blends. The invention includes two processes to form a useful end product. First, a thermoset material is formed from dissimilar polymers. The thermoset material is then melt blended with a thermoplastic material to produce the final product. In addition, U.S. Pat. No. 6,790,146 to Little et al., which is herein incorporated by reference in its entirety, discloses a thermokinetic mixer capable of forming useful products from a diverse mixture of post-consumer polymers.

Although these references address the difficulty of blending commingled, contaminated plastic products, these references do not directly address the ability to consistently form a product with certain minimum characteristics given the variability of the composition of post-consumer plastic waste. The compositions of post consumer plastic waste streams vary greatly from location to location and over time for a particular location. The variability causes an uncertainty in the quality of a product formed from the plastic waste. A number of industries that would consume such a product, however, require the plastic product to consistently have certain minimum characteristics. For example, the contract furniture industry has developed product requirements that were drafted through the Business and Institutional Furniture Manufacturer's Association (BIFMA) International and accredited by the American National Standards Institute (ANSI). In addition, a number of industries have internal industry standards that have not been accredited by a national standard. For example, the bedding industry has developed internal standards that reflect the real-world application strengths that are required for their products.

Accordingly, a method for forming plastic products from post-consumer plastic waste would be desirable. In addition, it would be advantageous if the method provided the ability to consistently form plastic products that may meet industry standards. Further, plastic products formed from such a method would also be beneficial.

### SUMMARY OF THE INVENTION

Embodiments of the present invention relate to methods for forming plastic products using post-consumer waste. In addition, embodiments of the present invention relate to plastic products formed from such methods. Accordingly, in one aspect, an embodiment of the present invention relates to a method for making a plastic product. The method includes providing a first composition comprising at least 30 weight percent of a first plastic and at least 30 weight percent paper products. The method also includes providing a second composition comprising at least 90 weight percent of a second plastic. The first composition is shredded to form a first shredded composition, and the second composition is shredded to form a second shredded composition. The first and second shredded compositions are commingled to form a shredded mixture. The method further includes heating the shredded mixture to form a shapeable plastic. The shapeable plastic is then placed in a mold and cooled to form the plastic product. In another aspect of the present invention, an embodiment relates to a plastic product formed from the above-described process.

A further aspect of the present invention relates to a plastic product comprising a blend of two compositions. The first composition comprises at least 30 weight percent a first plastic and at least 30 weight percent paper products. The second composition comprises at least 90 weight percent of a second plastic. The plastic product has a three point bend yield of greater than about 2500 psig, as determined by ASTM standard, D 790-92, test method 1.

In still another aspect of the present invention, an embodiment relates to a process for making a plastic product. The method includes providing a first composition comprising at least 30 weight percent of a first plastic and at least 30 weight percent paper products. The method also includes providing a second composition comprising at least 90 weight percent of a second plastic. The first and second compositions are commingled to form a first mixture, and the first mixture is shredded to form a shredded mixture. The method further includes heating the shredded mixture to form a shapeable plastic. The shapeable plastic is placed in a mold and cooled to form the plastic product. A further aspect of the invention is directed to the plastic product formed by the above-described process.

### BRIEF DESCRIPTION OF THE SEVERAL VIEWS OF THE DRAWINGS

Embodiments of the present invention are described in detail below with reference to the attached drawing figures, wherein:

FIGS. 1A-1E illustrate results from three point bend tests performed in accordance with ASTM standard, D 790-92, test method 1 on the plastic product formed as described in Example 1; and

FIGS. 2A-2G illustrate results from three point bend tests performed in accordance with ASTM standard, D 790-92, test method 1 on the plastic product formed as described in Example 2.

### DETAILED DESCRIPTION OF THE INVENTION

Embodiments of the present invention are directed to plastic products formed using post-consumer plastic waste, as well as methods of forming the plastic products. The process employs both a composition of post-consumer plastic waste and a high plastic content composition. The post-consumer plastic waste composition may be comprised of plastics of varying polymers and may contain a variety of contaminants, including paper products. The high plastic content composition is comprised primarily of plastic. The two compositions are shredded and mixed together in varying ratios. The mixture is then heated to form a shapeable plastic, which may be molded into a particular shape. The plastic product formed from the process contains predictable characteristics regarding the performance, strength, and life-cycle of the product, for example.

The first composition used in an embodiment of the present invention comprises a post-consumer plastic waste. The composition may be retrieved from any waste stream containing post-consumer plastics, such as recycling facilities and other solid waste streams. A wide range of constituent components may make up the composition, including a variety of plastics and contaminants. Because the composition is a post-consumer plastic waste, contaminants, such as labels, oil, adhesives, and solvents, may be present. The presence of such contaminants in the composition is acceptable. Further, the composition may be a high-paper content waste, having over 30 weight percent paper products.

The first composition is also comprised of at least 30 weight percent of a plastic. By way of example only and not limitation, the plastic may be comprised of one or more of the following polymers: polyethylene terephthalate (PET), high density polyethylene (HDPE), low density polyethylene (LDPE), polyvinyl chloride (PVC), polypropylene (PP), or polystyrene (PS). In one embodiment, the plastics contained within the first composition primarily comprise PE, PP, and PS based materials. However, it should be understood that other types of plastics may be employed within the scope of the present invention.

The make-up of post-consumer plastic waste streams used for the first composition varies for different locations. In addition, the make-up for a particular location will vary over time. Therefore, if plastic products were formed using only the first composition, the properties of the plastic products would vary widely. To produce a plastic product with predictable characteristics, the first composition is blended with a second composition to form the plastic product of the present invention. The second composition has a high-plastic content, comprising at least 90 weight percent of plastic. The plastic may be obtained from a variety of different sources and may be a recycled plastic waste itself. By way of example only and not limitation, the plastic may be comprised of one or more of the following polymers: polyethylene terephthalate (PET), high density polyethylene (HDPE), low density polyethylene (LDPE), polyvinyl chloride (PVC), polypropylene (PP), or polystyrene (PS). As with the first composition, it should be understood that other types of plastics may be employed within the scope of the present invention.

The two compositions are shredded to reduce the size of the material for further processing by the invention. Reducing the size of the material allows the two compositions to be thoroughly mixed. Although any size particle may be employed within the scope of the present invention, it is preferable to reduce the size of the materials from about 0.003 inches across to about 0.5 inches across. The compositions may be shredded using any standard size reducing equipment.

Either prior to or after shredding, the compositions are commingled to form a single mixture. In one embodiment, the compositions are first shredded individually and then commingled to form the mixture. In another embodiment, the compositions are first commingled, and the mixture is then shredded. The ratio of the first composition to the second composition in the commingled mixture may be adjusted to control the properties of the final plastic product. In one embodiment, the mixture is comprised of the first composition in an amount from about 10 to about 40 weight percent and the second composition in an amount from about 60 to about 90 weight percent. In a preferred embodiment, the mixture is comprised of the first composition in an amount from about 20 to about 30 weight percent and the second composition in an amount from about 70 to about 80 weight percent.

Blending the compositions during commingling to form a relatively uniform mixture helps ensure that the plastic product formed from the process has consistent characteristics throughout. Therefore, in an embodiment of the present invention, an apparatus, such as a tumble blender, is employed to provide a relatively uniform commingled mixture of the first and second compositions.

Because ferrous materials may cause significant wear on equipment used in the process, in embodiments of the present invention, ferrous containing materials may be removed from the compositions. The process may include a metal detection system to detect the presence of any ferrous containing materials. A magnetic system may then remove the ferrous containing materials from the compositions. It should be understood that the removal of ferrous containing materials may be carried out at any point in the process. For example, the removal may be prior to or after shredding. In addition, the removal of ferrous containing materials may be prior to or after the compositions are commingled.

After shredding and commingling the first and second compositions, the mixture is heated to blend the compositions and provide a shapeable plastic product. The mixture is preferably processed by a thermokinetic compounder, such as that disclosed in U.S. Pat. No. 6,709,146 to Little et al. (the '146 patent). The thermokinetic compounder disclosed therein provides the ability to melt blend a wide variety of plastics into a single plastic product while reducing the wear on and extending the life of the equipment. It should be understood that other types of thermokinetic mixers and extruders may also be employed within the scope of the present invention. In one embodiment, the mixture is preferably heated at a temperature from about 280 degrees Fahrenheit to about 390 degrees Fahrenheit for a period from about 6 seconds to 15 seconds.

A shapeable plastic product emerges from the apparatus used to melt blend the mixture of the first and second compositions. The shapeable plastic product may then be molded into a desirable shape. A variety of different types of molding process may be employed within the scope of the present invention. By way of example only and not limitation, the molding operation may include compression molding, injection molding, and profile extrusion. In one embodiment, the shapeable plastic product is placed in a mold and a hydraulic press applies pressure to the product. The shapeable plastic product is cooled in the mold to form the plastic product. It should be understood that any method of cooling, for example, air cooling and water cooling, may be employed with the scope of the present invention.

Embodiments of the present invention will now be illustrated by the following, non-limiting examples.

### EXAMPLE 1

A first and second composition comprised of household curbside plastic recycling were collected from a recycling facility in western Michigan. The first composition was a high paper content, post-consumer plastic waste and was comprised of approximately 50 weight percent of plastic and approximately 50 weight percent paper products. The second composition was a high plastic content composition that was comprised primarily of plastic (i.e. less than one weight percent of paper and other contaminants). The plastics of both the first and second compositions consisted primarily of a miscellaneous mixture of PET, HDPE, LDPE, PVC, PP, and PS polymers. Each of the compositions was individually shredded, and the shredded compositions were commingled to form a mixture comprised of 15 weight percent of the first composition and 85 weight percent of the second composition. The mixture was fed to a thermokinetic compounder, such as that disclosed in the '146 patent, and heated at a temperature between 280 degrees Fahrenheit and 390 degrees Fahrenheit for approximately six to twelve seconds to form a shapeable plastic composition. The shapeable plastic composition was then compression molded and cooled to form a plastic product.

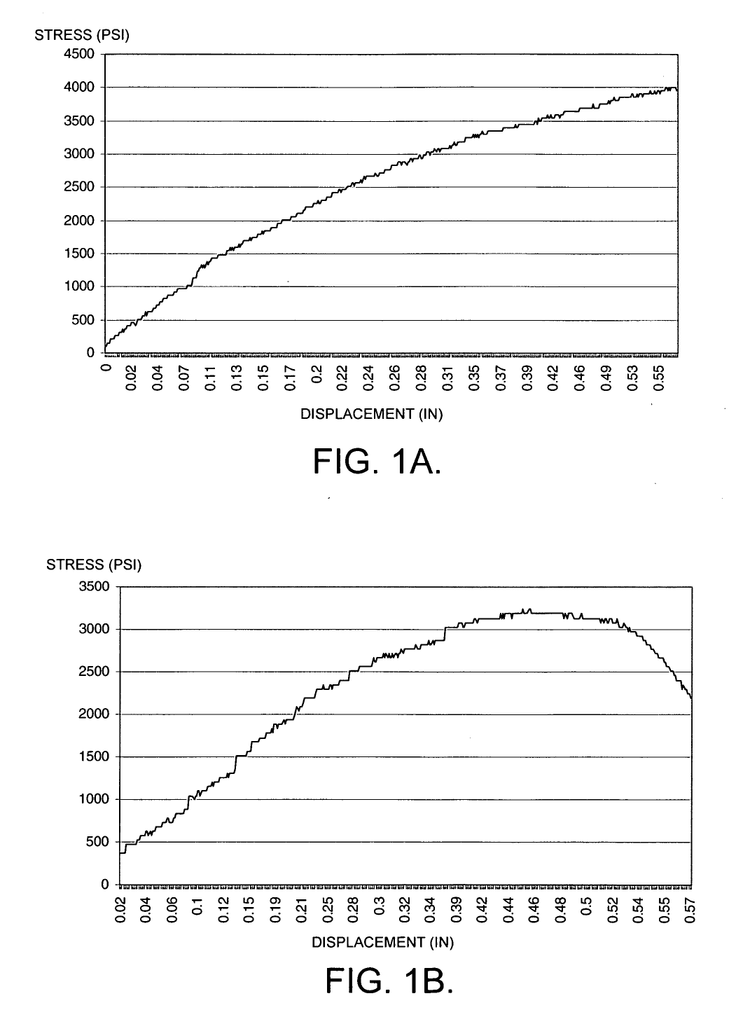

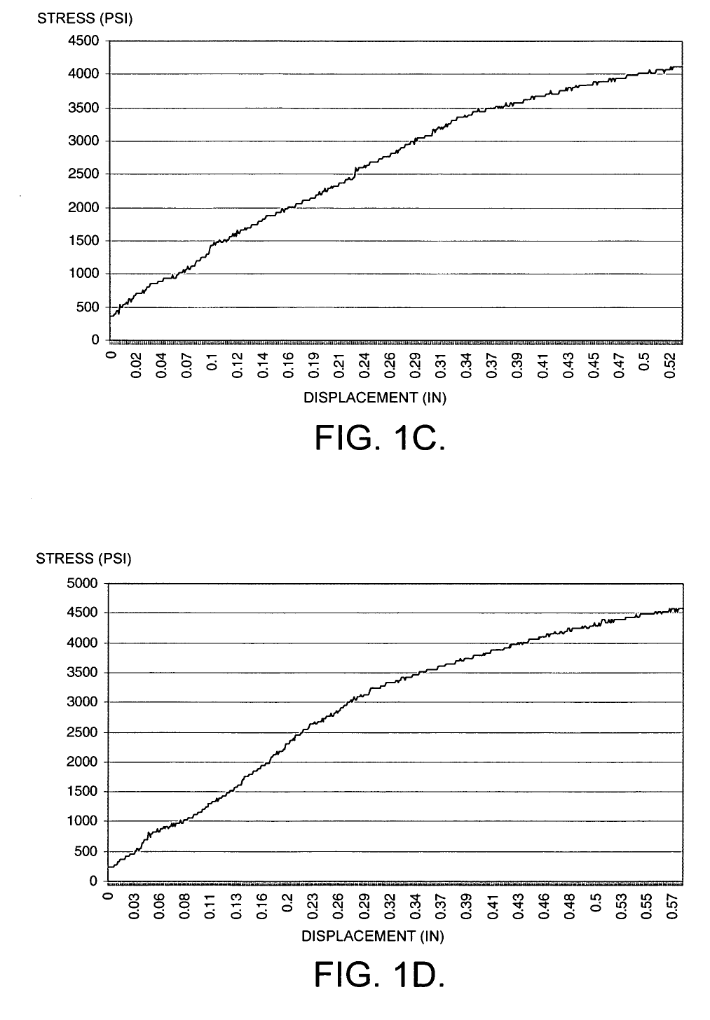

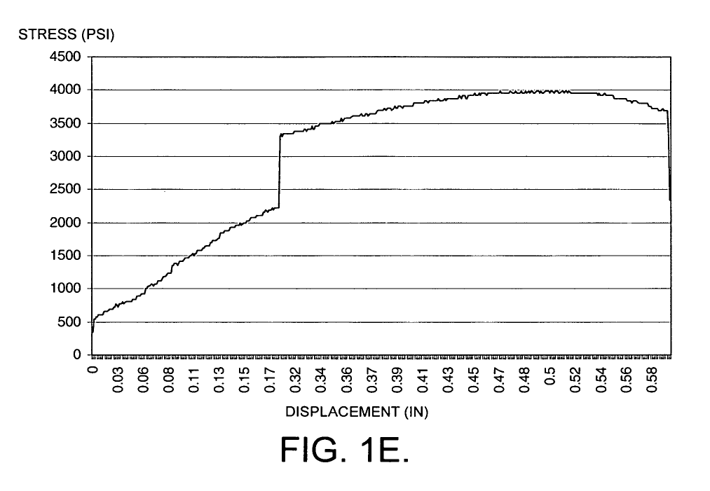

Three point bend tests were performed on the plastic product. The tests were performed according to ASTM standard, D 790-92, test method 1. Samples were cut from the plastic product to approximately ½ inch by 5 inches, and the material was approximately ¼ inch thick. The samples were laid across a 4-inch span and tested to the calculated strain failure. The results of each test are shown in the graphs of FIGS. 1A-1E, each graph showing the displacement (measured in inches) at varying stresses (measured in pounds per square inch). Table 1 below shows the stress at the ASTM displacement for each test. The average stress at the ASTM displacement for all of the tests performed was 3719.82 psi.

TABLE 1
Stress at ASTM Displacement

| | Stress (psi) at |
|---|---|
| Test | ASTM Displacement |
| 1 | 3855.52 |
| 2 | 3031.26 |
| 3 | 3983.61 |
| 4 | 4248.31 |
| 5 | 3956.51 |

### EXAMPLE 2

A second plastic product was formed using the same first and second compositions and the same method described above under Example 1. The mixture used to form the second plastic product, however, was comprised of 25 weight percent of the first composition and 75 weight percent of the second composition.

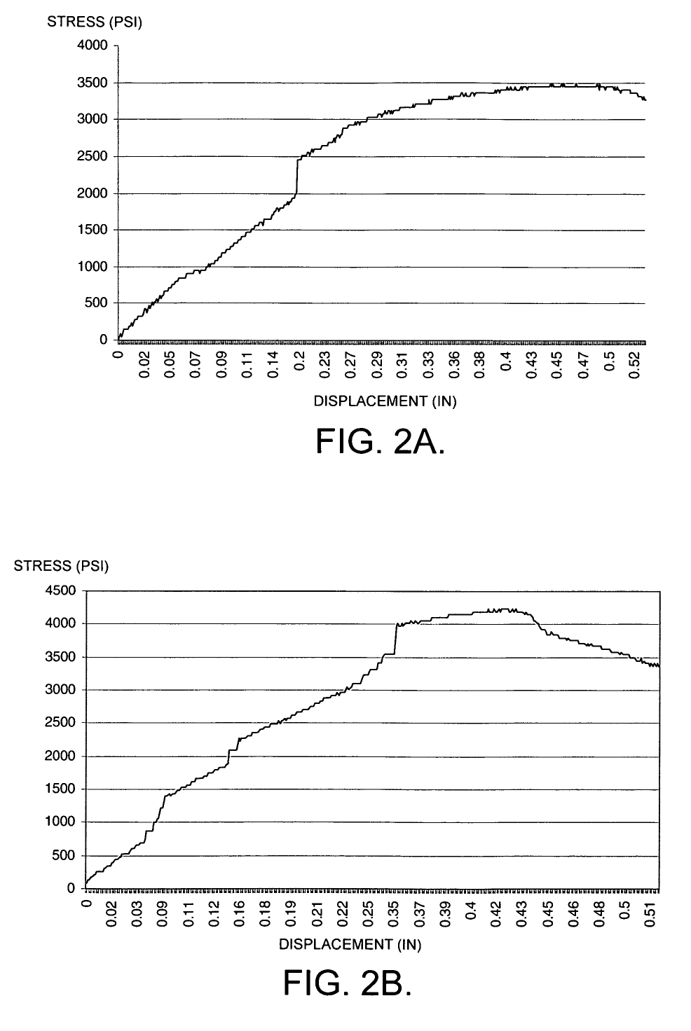

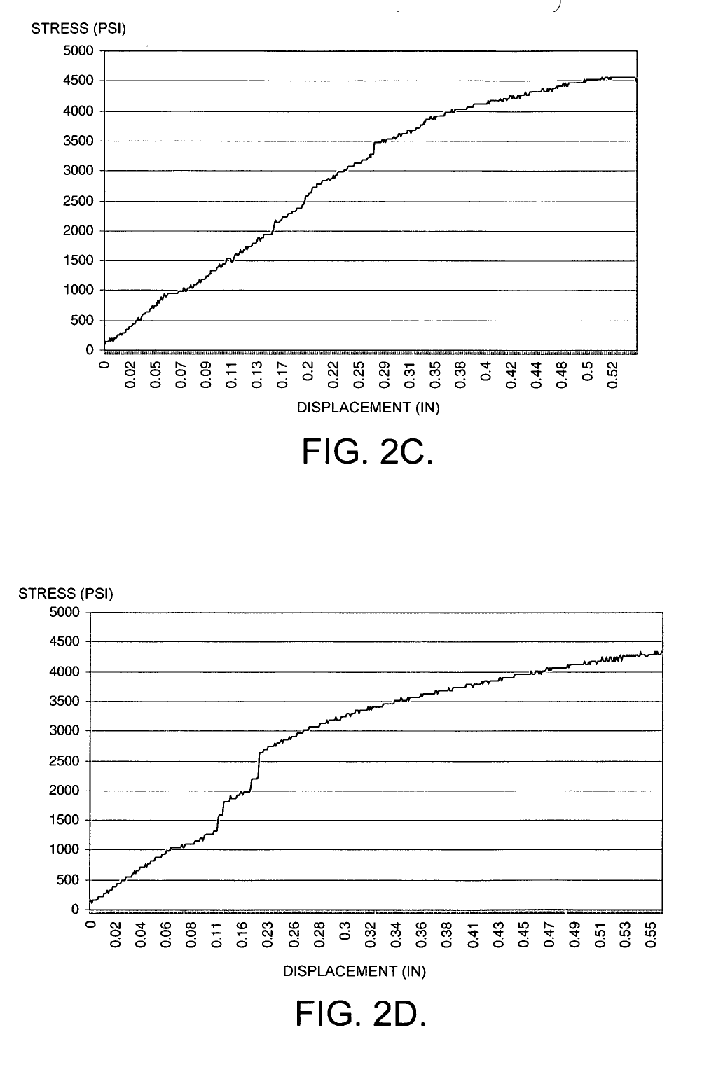

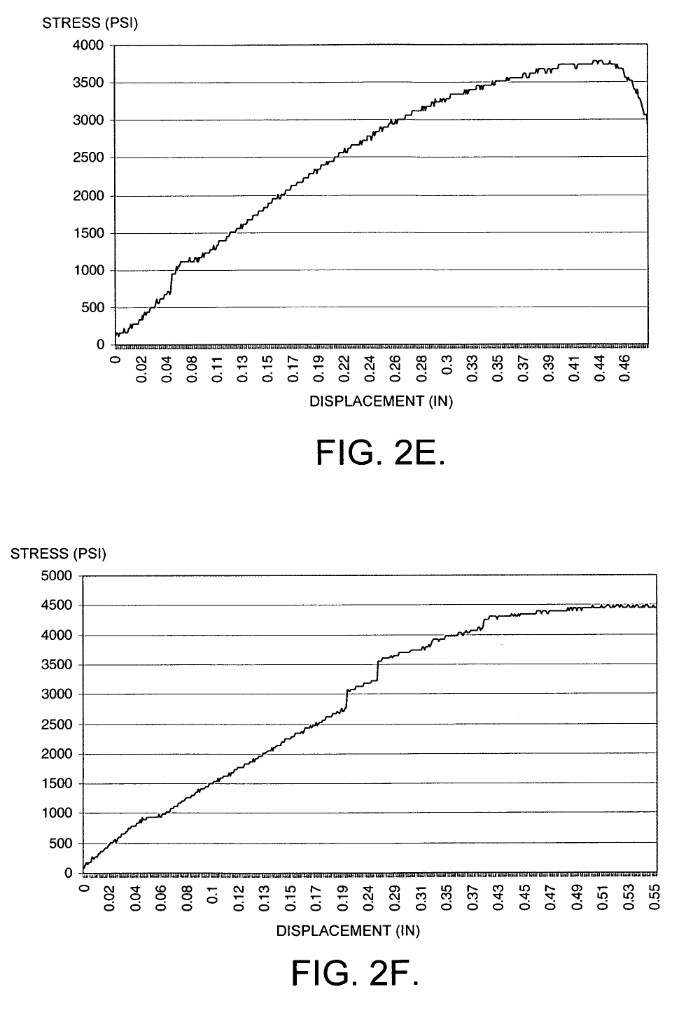

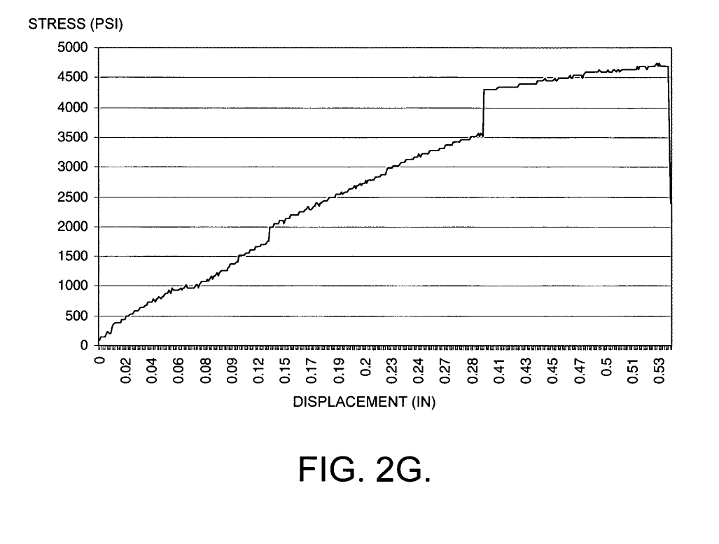

Three point tests, as discussed above in Example 1, were similarly performed on the second plastic product. The results of each test are shown in the graphs of FIGS. 2A-2G. each graph showing the displacement (measured in inches) at varying stresses (measured in pounds per square inch). Table 2 below shows the stress at the ASTM displacement for each test. The average stress at the ASTM displacement for all of the tests performed was 4101.18 psi.

TABLE 2
Stress at ASTM Displacement

| | Stress (psi) at |
|---|---|
| Test | ASTM Displacement |
| 1 | 3405.23 |
| 2 | 3623.89 |
| 3 | 4517.38 |
| 4 | 4293.26 |
| 5 | 3787.51 |
| 6 | 4441.91 |
| 7 | 4639.08 |

While various embodiments of the present invention have been described in detail, it is apparent that modifications and adaptations of those embodiments will occur to those skilled in the art. It is to be expressly understood, however, that such modifications and adaptations are within the spirit and scope of the present invention.

The invention claimed is:

1. A process for making a plastic product, comprising the steps of:
(a) providing a first composition comprising at least 30 weight percent of a first plastic and at least 30 weight percent paper products;
(b) providing a second composition comprising at least 90 weight percent of a second plastic;
(c) shredding the first composition to form a first shredded composition;
(d) shredding the second composition to form a second shredded composition;
(e) commingling the first and second shredded compositions to form a shredded mixture;
(f) heating the shredded mixture to form a shapeable plastic;
(g) molding the shapeable plastic in a mold; and
(h) cooling the shapeable plastic in the mold to form the plastic product.

2. The process of claim 1, wherein the plastic product has a three point bend yield of greater than about 2500 psig, as determined by ASTM standard, D 790-92 test method 1.

3. The process of claim 2, wherein the three point bend yield is greater than about 3000 psig.

4. The process of claim 1, wherein the plastic product has an ultimate tensile strength yield of greater than about 2000 psig, as determined by ASTM standard 638.

5. The process of claim 1, wherein the shredded mixture comprises the first shredded composition in an amount from about 10 to about 40 weight percent, and the shredded mixture comprises the second shredded composition in an amount from about 60 to about 90 weight percent.

6. The process of claim 1, wherein the shredded mixture comprises the first shredded composition in an amount from about 20 to about 30 weight percent, and the shredded mixture comprises the second shredded composition in an amount from about 70 to about 80 weight percent.

7. The process of claim 1, wherein the first plastic comprises a polymer selected from the group consisting of polyethylene terephthalate, high density polyethylene, low density polyethylene, polyvinyl chloride, polypropylene, polystyrene, and mixtures thereof.

8. The process of claim 1, wherein the second plastic comprises a polymer selected from the group consisting of polyethylene terephthalate, high density polyethylene, low density polyethylene, polyvinyl chloride, polypropylene, polystyrene, and mixtures thereof.

9. The process of claim 1, wherein step (f) occurs in a thermokinetic compounder.

10. The process of claim 1, wherein the first composition comprises iron-containing compositions, the process further comprising the step of:
(i) removing at least a portion of iron from the first shredded composition or the shredded mixture.

11. The process of claim 1, wherein step (f) occurs in less than about 10 seconds.

12. The plastic product formed by the process of claim 1.

13. The plastic product of claim 12, wherein the plastic product has a three point bend yield of greater than about 2500 psig, as determined by ASTM standard, D 790-92 test method 1.

14. The plastic product of claim 13, wherein the three point bend yield is greater than about 3000 psig.

15. The plastic product of claim 12, wherein the plastic product has an ultimate tensile yield of greater than about 2000 psig, as determined by ASTM standard 638.

16. The plastic product of claim 12, wherein the weight ratio of the first composition to the second composition in the plastic product ranges from about 5:95 to about 25:75.

17. The plastic product of claim 16, wherein the weight ratio of the first composition to the second composition in the plastic product ranges from about 10:90 to about 20:80.

18. The plastic product of claim 17, wherein the weight ratio of the first composition to the second composition in the plastic product is about 15:85.

19. A plastic product, comprising a blend of:
(a) a first composition comprising at least 30 weight percent a first plastic and at least 30 weight percent paper products; and
(b) a second composition comprising at least 90 weight percent of a second plastic, wherein the plastic product has a three point bend yield of greater than about 2500 psig, as determined by ASTM standard, D 790-92 test method 1.

20. The plastic product of claim 19, wherein the three point bend test value is greater than about 3000 psig.

21. The plastic product of claim 19, wherein the plastic product has an ultimate tensile strength yield of greater than about 2000 psig, as determined by ASTM standard 638.

22. The plastic product of claim 19, wherein the first plastic comprises a polymer selected from the group consisting of polyethylene terephthalate, high density polyethylene, low density polyethylene, polyvinyl chloride, polypropylene, polystyrene, and mixtures thereof.

23. The plastic product of claim 19, wherein the second plastic comprises a polymer selected from the group consisting of polyethylene terephthalate, high density polyethylene, low density polyethylene, polyvinyl chloride, polypropylene, polystyrene, and mixtures thereof.

24. The plastic product of claim 19, wherein the first plastic comprises polypropylene and the second plastic comprises polyethylene.

25. The plastic product of claim 19, wherein the weight ratio of the first composition to the second composition in the plastic product ranges from about 5:95 to about 25:75.

26. The plastic product of claim 25, wherein the weight ratio of the first composition to the second composition in the plastic product ranges from about 10:90 to about 20:80.

27. The plastic product of claim 26, wherein the weight ratio of the first composition to the second composition in the plastic product is about 15:85.

28. A process for making a plastic product, comprising the steps of:
(a) providing a first composition comprising at least 30 weight percent of a first plastic and at least 30 weight percent paper products;
(b) providing a second composition comprising at least 90 weight percent of a second plastic;
(c) commingling the first and second compositions to form a first mixture;
(d) shredding the first mixture to form a shredded mixture;
(e) heating the shredded mixture to form a shapeable plastic;
(f) molding the shapeable plastic in a mold; and
(g) cooling the shapeable plastic in the mold to form the plastic product.
